(19) United States
(12) Patent Application Publication
(10) Pub. No.: US 2006/0153748 A1
(43) Pub. Date: Jul. 13, 2006

(54) Exhaust gas after treatment system, especially for a diesel engine

(76) Inventors: Georg Huthwohl, Soest (DE); Bernd Maurer, Balve (DE)

Correspondence Address: RICK MARTIN;PATENT LAW OFFICES OF RICK MARTIN, PC, 416 COFFMAN STREET, LONGMONT, CO, 80501, US

(21) Appl. No.: 10/532,530

(22) PCT Filed: Oct. 2, 2003
(86) PCT No.: PCT/EP03/10917

§ 371 Date: Oct. 31, 2005

(30) Foreign Application Priority Data
Oct. 25, 2002 (DE) 102 50 050.9

(51) Int. Cl. B01D 53/34; B01D 50/00

(52) U.S. Cl. 422/172; 422/168

(57) ABSTRACT

Exhaust gas aftertreatment system, especially for a diesel engine.

The invention proposes an exhaust gas aftertreatment system having an exhaust gas particulate filter (3), a nitrogen oxide reduction catalytic converter (7, 8) connected downstream of the exhaust gas particulate filter, and an apparatus (17) for adding reducing agent.

As claimed in the invention, the exhaust gas particulate filter (3) is designed as a porous cylindrical filter body having a substantially radial exhaust gas inflow direction into the filter body, a filter inner region (26) for filtered exhaust gas, and an axial exhaust gas outflow direction out of the filter inner region (26), and reducing agent is added into the filter inner region (26) via the apparatus (17) for adding reducing agent. Use in motor vehicles, in particular in commercial vehicles.

### CROSS REFERENCE APPLICATIONS

This application is a national stage application claiming priority from PCT application no. PCT/EP03/109171 filed on Oct. 2, 2003 and claiming priority from German application 102 50 050.96 filed on Oct. 25, 2002.

### FIELD OF INVENTION

The invention relates to an exhaust gas after treatment system, especially for a diesel engine, having the features of the preamble of claim 1.

### BACKGROUND OF THE INVENTION

German laid-open specification DE 100 42 542 A1 has described an exhaust gas after treatment system having an exhaust gas particulate filter and an SCR catalytic converter. The exhaust gas particulate filter and the SCR catalytic converter are arranged in the housing of the exhaust gas after treatment system and form a structural unit therewith. Urea is used as a reducing agent for the selective catalytic reduction of nitrogen oxides and is injected into a special tube element. The special tube element is arranged in the housing parallel to the exhaust gas particulate filter and has filtered exhaust gas flowing through it, with the urea then being fed to the SCR catalytic converter. In the housing there is a plurality of chambers which are separated from one another by partitions and act as reflection chambers and/or absorption chambers, thereby producing a muffling action.

It is an object of the invention to provide an exhaust gas after treatment system which can achieve comprehensive exhaust gas purification, which is of structurally simple and compact configuration and can be used for optimum sound muffling.

According to the invention, this object is achieved by an exhaust gas after treatment system having the features of claim 1.

### SUMMARY OF THE INVENTION

According to the invention, the exhaust gas particulate filter is formed as a porous cylindrical filter body having a substantially radial exhaust gas inflow direction into the filter body, a filter inner region for filtered exhaust gas, and an axial exhaust gas outflow direction out of the filter inner region, and there is provision for reducing agent to be added into the filter inner region by means of the apparatus for adding reducing agent.

The filter body is designed as a cylindrical hollow body with a porous cylinder wall and is preferably configured in such a way that filtered exhaust gas can flow out of the filter inner region in the axial direction on one side. The filter inner region in this context is to be understood as meaning the volume region which can be filled with filtered exhaust gas upstream of the outflow side filter body end. The wall material of the filter body can act as a depth filter or as a surface filter and may be formed from any desired porous material which has a filtering action and is able to withstand exhaust gases, for example metal foam or ceramic foam. Moreover, it may additionally be provided with a catalytic coating on the outer side, the inner side or in the porous interior of the material.

A suitable nitrogen oxide reduction catalytic converter is any catalytic converter which is able to catalyze the reduction of nitrogen oxides by a suitable reducing agent. The reducing agent used may be any reagent which has a nitrogen oxide reduction activity. The nitrogen oxide reduction catalytic converter is preferably designed as a standard SCR catalytic converter based on vanadium pentoxide, and therefore the reducing agent is ammonia or a liquid from which ammonia can be released. It is preferable for the reducing agent used to be aqueous urea solution. Accordingly, the apparatus for adding reducing agent is preferably designed as an injection nozzle.

The particulate filter and the downstream nitrogen oxide reduction catalytic converter may be arranged in separate housings or in a common housing.

The addition of reducing agent into the inner region of the filter body results in a space saving design solution with short gas paths. This prevents cooling of the exhaust gas before the reducing agent is added, resulting in favorable thermal conditions for preparation of the reducing agent, for example for release of the ammonia or for evaporation. Moreover, the addition of reducing agent into the filter inner region achieves a good uniform distribution and homogenization of the reducing agent in the exhaust gas.

In one configuration of the invention, the filter body is formed by porous filter plate rings which are combined in pairs. It is preferable for the filter body to be formed from flat, annular sintered-metal filter plates which are fixedly joined to one another, for example by a weld seam, alternately and in pairs along their outer circumference and along their inner ring circumference. It is preferable for the filter body to have a sealed end plate at one end, while an annular, gastight end plate is arranged at the other end; the filtered exhaust gas can flow out of the opening in the annular end plate in the axial direction. The filter plate rings may be of any desired shape, but it is preferable for them to be approximately round with a central hole in the middle. This produces a cylindrical filter body with a shape similar to an accordion with contours that are approximately in zigzag form when seen in longitudinal section. This is distinguished by a large filter surface area and a low pressure loss, as well as a high muffling action. This makes it possible to substantially dispense with any further structural muffling measures in the exhaust gas aftertreatment system.

In a further configuration of the invention, the nitrogen oxide reduction catalytic converter and the particulate filter are arranged in a common housing. This avoids the need for multiple exhaust gas connections and produces a compact structure of the exhaust gas aftertreatment system. In particular in the case of an exhaust gas particulate filter constructed from sintered-metal filter rings, an exhaust gas muffler with an exhaust gas purification function is realized by this structure on account of its muffling action.

In a further configuration of the invention, there are flow guiding means for passing on filtered exhaust gas to the nitrogen oxide reduction catalytic converter, which flow guiding means comprise a collection manifold led out of the filter inner region of the filter body. If the filter body is constructed from sintered-metal filter rings, the collection manifold, in addition to collecting and passing on exhaust gas, also serves to increase mechanical stability. The individual filter plate rings can be supported on the collection manifold. In the filter inner region, the collection manifold preferably has a perforated wall for the exhaust gas entry. If the nitrogen oxide reduction catalytic converter and the particulate filter are arranged in a common housing, it is furthermore possible for one or more partition walls to be arranged suitably in the housing, by which partitions the housing is divided into chambers. In this case, the partition or partitions likewise serve as flow guiding means for passing on filtered exhaust gas to the nitrogen oxide reduction catalytic converter or serve to route the exhaust gas flow in some other way in the interior of the housing and at the same time prevent back-mixing.

In a further configuration of the invention, a catalytic converter element is arranged in the collection manifold. A catalytic converter element of this type, as seen in the direction of flow of the exhaust gas, may be arranged both in the filter inner region preferably just downstream of the location where the reducing agent is added, or further downstream. In the case of the urea being used as the reducing agent, it is preferably designed as a hydrolysis catalytic converter which promotes the release of ammonia. The arrangement of the catalytic converter element according to the invention produces a particularly compact and space-saving overall design.

In a further configuration of the invention, the nitrogen oxide reduction catalytic converter is arranged axially parallel and adjacent to the collection manifold. In an arrangement of this type, the nitrogen oxide reduction catalytic converter may comprise one or more catalytic converter parts. If the nitrogen oxide reduction catalytic converter is of multi-part design, it is preferable for the individual catalytic converter parts to be arranged axially parallel around the collection manifold. This embodiment allows the volume of the nitrogen oxide reduction catalytic converter to be increased in a space-saving way.

In a further configuration of the invention, an oxidation catalytic converter is connected upstream of the exhaust gas particulate filter, as seen in the direction of flow of the exhaust gas. This can be realized by a separate catalytic converter element in a separate housing or in the housing in which the exhaust gas particulate filter is arranged. The oxidation catalytic converter is used, for example, to oxidize hydrocarbons or to oxidize nitrogen monoxide to form nitrogen dioxide. The latter improves the regeneration behavior of the particulate filter.

In a further configuration of the invention, the exhaust gas particulate filter and the oxidation catalytic converter are arranged in a common housing. This arrangement produces a particularly compact structural unit.

In a further configuration of the invention, an exhaust gas recirculation line which is led out of the filter inner region for branching off a part-stream of filtered exhaust gas upstream of the addition of reducing agent and for recirculating this part-stream of filtered exhaust gas to the diesel engine is provided. The result of this measure is that filtered exhaust gas that is free of reducing agent in the exhaust gas recirculation line is fed to the diesel engine. This prevents condensation in the components which come into contact with the recirculated exhaust gas.

Other aspects of this invention will appear from the following description and appended claims, reference being made to the accompanying drawings forming a part of this specification wherein like reference characters designate corresponding parts in the several views.

### BRIEF DESCRIPTION OF THE DRAWINGS

FIG. 1 is a diagrammatic sectional illustration of an embodiment of the exhaust gas purification system according to the invention.

FIG. 2 is a diagrammatic sectional illustration of a further embodiment of the exhaust gas purification system according to the invention.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF THE DRAWINGS

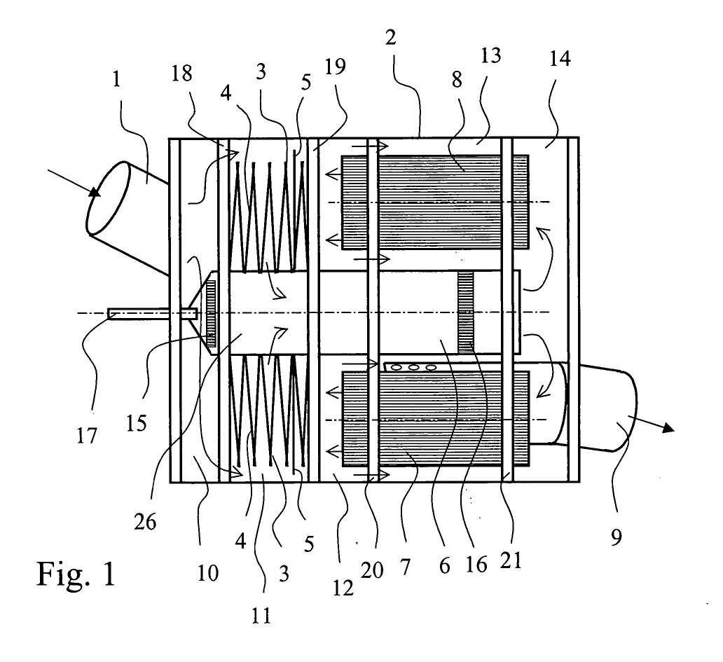

FIG. 1 diagrammatically depicts a longitudinal section through an embodiment of the exhaust gas purification system according to the invention. In the present case, this system comprises a particulate filter 3 and an SCR catalytic converter comprising two honeycomb monoliths 7, 8, which are arranged in a common housing 2 having an entry tube 1 and an outflow tube 9. A collection manifold 6 and partitions 18, 19, 20, 21 are provided in the housing 2 for the purpose of routing the exhaust gas. The way in which the exhaust gas purification system functions is explained below with reference to the description of the exhaust gas flow path, which is diagrammatically indicated by arrows.

Exhaust gas from a diesel engine (not shown) flows through the entry tube 1 into an inflow chamber 10 of the housing 2. The partition 18 separates the inflow chamber 10 from a particulate filter chamber 11, in which the particulate filter 3 is arranged. Along its circumference, the partition 18 is joined to the housing 2, but it has apertures in the form of holes, preferably arranged in a ring along its edge region. These apertures allow the exhaust gas which has flowed into the inflow chamber 10 to pass into the particulate filter chamber 11. The partition 19 delimits the other end side of the particulate filter chamber 11 and prevents unfiltered exhaust gas from being transferred onward into the part of the housing located further downstream

The particulate filter 3 is constructed from individual filter rings, of which just one filter ring 4 is provided, as a representative example, with a reference numeral. The individual filter rings are designed as sintered-metal filter plates with a central hole and are fixedly joined to one another, for example by a weld seam, on alternate sides and in pairs along their outer circumference and along their inner ring circumference. This forms a filter body which is accordion-like in form with outer and inner filter pockets. The end-side filter rings of the filter body are joined in a gastight manner to the respective partitions 18, 19 all the way around. The exhaust gas which has entered the particulate filter chamber 11 therefore flows onward through the filter rings of the filter body into the filter inner region 26, with particulates contained in the exhaust gas being filtered out in the process. The main direction of flow of the exhaust gas therefore runs radially from the outer region of the filter body into its inner region 26.

In the filter inner region 26, the filtered exhaust gas is received by a collection manifold 6, which is designed with perforations on its lateral surface in the interior of the filter body. The collection manifold 6 preferably has the same cross section as the holes in the sintered-metal filter plates over the majority of its length; consequently, the sintered-metal filter plates are supported against the collection manifold 6 in the form of a ring all the way around it in the interior of the filter body, resulting in a high mechanical stability of the filter body.

At encircling gastight connections, the collection manifold 6 is routed out of the particulate filter chamber 11, on one side through partition 18 and on the other side through partitions 19, 20, 21, into the inflow chamber 10 and into a first diversion chamber 14, respectively. In the region of the inflow chamber 10, an apparatus for adding reducing agent is connected in a gastight manner to the collection manifold 6. This apparatus is only diagrammatically indicated in FIG. 1, as a feed line 17 for a urea and water solution, which is routed into the collection manifold 6, which narrows at the corresponding end. Urea and water solution as reducing agent can be injected into the filter inner region 26 through the feed line 17, in a manner which is targeted and in accordance with demand but is not indicated in more detail here. It is preferable for the injection of the urea and water solution to be assisted by compressed air. In the end region of the feed line 17, the collection manifold 6 widens out in the direction of flow, resulting in a good uniform distribution of the reducing agent supplied in the filter inner region 26. To further improve the distribution of reducing agent, for example by swirling it up, the collection manifold 6 may be provided, in the conically narrowing end region, with holes (not shown) which allow a small quantity of unfiltered exhaust gas from the inflow chamber 10 to enter the collection manifold 6. This results in further improved mixing of the reducing agent which is added with filtered exhaust gas in the upstream region of the collection manifold 6.

To prepare the reducing agent which has been added and/or to improve the release of ammonia from the urea which is added, it is possible for a suitable catalytic converter to be arranged in the collection manifold 6. This catalytic converter is in this case embodied by the catalytic converter disks 15 and 16, which act as hydrolysis catalysts prompting the decomposition of urea and the release of ammonia. The hydrolysis catalyst may in principle be arranged at any desired location in the collection manifold 6 downstream of the addition of urea, but it is preferable for a first catalytic converter part 15 to be arranged just downstream of the addition of the urea and for a second catalytic converter part 16 to be arranged in the end region of the collection manifold 6. The hydrolysis catalyst may in this case be designed such that it can be electrically heated completely or in parts, in order to further improve the decomposition of urea.

The exhaust gas which has been mixed with the reducing agent is passed through the collection manifold 6 until it reaches a first diversion chamber 14, where it emerges from the end-side opening of the collection manifold 6. From there, it is fed to the nitrogen oxide reduction catalytic converter. The latter is in this case realized by two cylindrical SCR catalytic converter monoliths 7, 8, which are arranged axially parallel and adjacent to the collection manifold 6. However, it is, of course, also possible to arrange further catalytic converter parts fitted around the collection manifold 6. At their entry side end the SCR catalytic converters 7, 8 are passed through corresponding openings in the partition 21, in a manner which is sealed all around. The partition 21 is joined to the housing 2 in a fixed and gastight manner along its circumference, and therefore serves both as a flow guiding means for the exhaust gas or exhaust gas/reducing agent mixture and as a mechanical holder for the SCR catalytic converters 7, 8 and the collection manifold 6. At their exit side end, the SCR catalytic converters 7, 8 are passed through corresponding openings in the partition 20, although here the SCR catalytic converters 7, 8 do not necessarily have to be fitted in a gastight manner into the corresponding openings in the partition 20.

The exhaust gas, which is purified by the removal of nitrogen oxides as it passes through the SCR catalytic converters 7, 8 emerges from the SCR catalytic converters 7, 8 in a second diversion chamber, which is laterally delimited by the partitions 19, 20. Since the partition 20 is of partially perforated design, whereas the partition 19 forms a gastight closure with respect to the particulate filter chamber 11, the purified exhaust gas, after its direction of flow has changed, is passed onward through the perforated partition 20 into an outflow chamber 13.

In the outflow chamber 13, the exhaust gas is received by an outflow tube 9, which is routed from there through the partition 21 and the wall of the housing 2 and then out of the housing 2, so that the exhaust gas is passed out of the housing 2. The outflow tube 9 is preferably of perforated design at its entry-side end region and provided with a perforated end plate. This, like the perforations in the partitions 18 and 20, makes a contribution to muffling.

The embodiment described therefore forms an exhaust gas after treatment system which is of structurally simple and compact configuration and can achieve comprehensive exhaust gas purification and, in addition, particularly effective muffling.

The purifying action of the exhaust gas after treatment system according to the invention can be improved further by adding an additional catalytic function. This may consist, for example, in a catalytically active coating applied to the inflow side or outflow side surface of the filter rings. However, the catalytic function may also be realized by sintered material filter rings in which the sintered material itself has a catalytic activity. Furthermore, it is possible for the catalytic function to be realized by plate elements with an oxidation/catalyzing action, for example, secured to the filter body. FIG. 1 illustrates a single catalytic plate element 5 of annular design as a representative example of possibly a plurality of catalytic plate elements of this type. This catalytic plate element 5 extends in the radial direction into the outer region of the filter body. It is preferable for the filter body to be designed in accordance with what is described in German laid-open specification DE 100 35 544 A1 and provided with catalytically active plate elements.

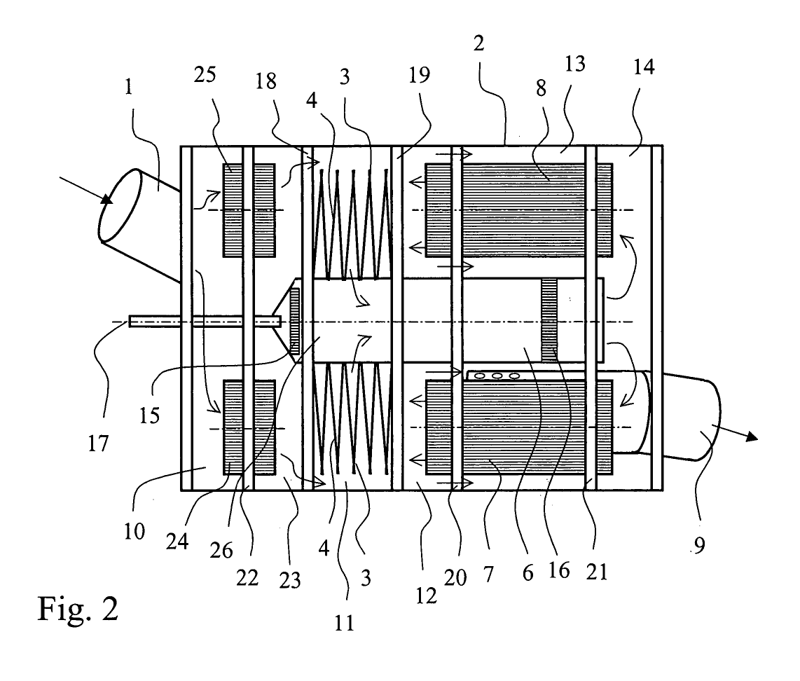

FIG. 2 illustrates a further advantageous embodiment of the exhaust gas after treatment system according to the invention. In this case, the components of the arrangement shown in FIG. 2, where they correspond to the parts shown in FIG. 1, are denoted by the same reference numerals.

The exhaust gas after treatment system illustrated in FIG. 2 differs from the system illustrated in FIG. 1 substantially by virtue of having an oxidation catalytic converter, which in this case comprises two honeycomb monoliths 24, 25 and which is connected upstream of the particulate filter 3, as seen in the direction of flow of the exhaust gas. For this purpose, an intermediate chamber 23 has been added to the housing 2 compared to the embodiment illustrated in FIG. 1. The intermediate chamber 23 separates the inflow chamber 10 from the particulate filter chamber 11 by means of the partition 22. The partition 22 has openings for the feed line 17 to pass through in a gastight manner and for receiving the catalytic converter bodies 24, 25 such that they are sealed all the way around, and moreover this partition 22 separates the inflow chamber 10 from the intermediate chamber 23 in a gastight manner. The exhaust gas which flows into the inflow chamber 10 of the housing 2 via the entry tube 1 is therefore passed into the intermediate chamber 23 via the catalytic converter bodies 24, 25 before it is fed into the particulate filter chamber 11. As a result, the exhaust gas undergoes an oxidation-catalyzing treatment before it is filtered, during which treatment the level of oxidizable constituents, such as hydrocarbons or carbon monoxide, in the exhaust gas is reduced. Furthermore, nitrogen monoxide contained in the exhaust gas can be oxidized to form nitrogen dioxide, thereby facilitating the burn-off of carbon particulates that have been deposited on the filter body. This embodiment makes it possible to dispense with the plate elements with an oxidation-catalyzing action secured to the filter body of the embodiment illustrated in FIG. 1.

Further improvement to the emission of pollutants can be achieved by exhaust gas recirculation. For this purpose, an exhaust gas recirculation line (not shown), which opens out into the filter inner region 26 upstream of the addition of reducing agent is routed out of the housing 2 and connected to the intake pipe system of the engine. In this way, filtered exhaust gas without any reducing agent can be recirculated to the engine. The exhaust gas recirculation described can of course be realized both in the embodiment shown in FIG. 1 and in the embodiment shown in FIG. 2.

I claim:

1-9. (canceled)

10. An exhaust gas after treatment system, especially for a diesel engine comprising:
an exhaust gas particulate filter,
a nitrogen oxide reduction catalytic converter connected downstream of the exhaust gas particulate filter, as seen in the direction of flow of the exhaust gas,
an apparatus for adding reducing agent,
wherein the exhaust gas particulate filter is designed as a porous cylindrical filter body having a filter inner region for filtered exhaust gas, and in that reducing agent is added into the filter inner region via the apparatus for adding reducing agent.

11. The exhaust gas after treatment as claimed in claim 10, wherein the filter body is designed as a cylindrical hollow body with a porous wall.

12. The exhaust gas after treatment system as claimed in claim 11, wherein the filter body is formed by porous filter plates which are combined in pairs.

13. The exhaust gas after treatment system as claimed in claim 10, wherein the exhaust gas particulate filter and the nitrogen oxide reduction catalytic converter are arranged in a common housing.

14. The exhaust gas after treatment system as claimed in claim 11, wherein the exhaust gas particulate filter and the nitrogen oxide reduction catalytic converter are arranged in a common housing.

15. The exhaust gas after treatment system as claimed in claim 12, wherein the exhaust gas particulate filter and the nitrogen oxide reduction catalytic converter are arranged in a common housing.

16. The exhaust gas after treatment system as claimed in claim 10, wherein an oxidation catalytic converter is connected upstream of the exhaust gas particulate filter, as seen in the direction of flow of the exhaust gas.

17. The exhaust gas after treatment system as claimed in claim 11, wherein an oxidation catalytic converter is connected upstream of the exhaust gas particulate filter, as seen in the direction of flow of the exhaust gas.

18. The exhaust gas after treatment system as claimed in claim 12, wherein an oxidation catalytic converter is connected upstream of the exhaust gas particulate filter, as seen in the direction of flow of the exhaust gas.

19. The exhaust gas after treatment system as claimed in claim 13, wherein an oxidation catalytic converter is connected upstream of the exhaust gas particulate filter, as seen in the direction of flow of the exhaust gas.

20. The exhaust gas after treatment system as claimed in claim 14, wherein an oxidation catalytic converter is connected upstream of the exhaust gas particulate filter, as seen in the direction of flow of the exhaust gas.

21. The exhaust gas after treatment system as claimed in claim 15, wherein an oxidation catalytic converter is connected upstream of the exhaust gas particulate filter, as seen in the direction of flow of the exhaust gas.

22. The exhaust gas after treatment system as claimed in claim 16, wherein the exhaust gas particulate filter and the oxidation catalytic converter are arranged in a common housing.

23. The exhaust gas after treatment system as claimed in claim 17, wherein the exhaust gas particulate filter and the oxidation catalytic converter are arranged in a common housing.

24. The exhaust gas after treatment system as claimed in claim 18, wherein the exhaust gas particulate filter and the oxidation catalytic converter are arranged in a common housing.

25. The exhaust gas after treatment system as claimed in claim 19, wherein the exhaust gas particulate filter and the oxidation catalytic converter are arranged in a common housing.

26. The exhaust gas after treatment system as claimed in claim 20, wherein the exhaust gas particulate filter and the oxidation catalytic converter are arranged in a common housing.

27. The exhaust gas after treatment system as claimed in claim 21, wherein the exhaust gas particulate filter and the oxidation catalytic converter are arranged in a common housing.
